(19) United States
(12) Patent Application Publication
(10) Pub. No.: US 2026/0222421 A1
(43) Pub. Date: Jul. 30, 2026

(54) OPERATIONALLY INDEPENDENT ATTACK SIGNATURES IN AUTONOMOUS PENTESTING

(71) Applicant: Horizon 3 AI, Inc., Dover, DE (US)

(72) Inventor: Justin Lloyd Cady, North Augusta, SC (US)

(21) Appl. No.: 19/039,557

(22) Filed: Jan. 28, 2025

(51) Int. Cl. H04L 9/40

(52) U.S. Cl. CPC H04L 63/1416; H04L 63/1433

(57) ABSTRACT

A computing service may obtain, from devices associated with an autonomous pentesting operation of a target network, sorted node adjacency information associated with an attack path of the autonomous pentesting operation of the target network, where the attack path represents an unauthorized access to one or more aspects of the target network. The computing service may hash the sorted node adjacency information via a hash function to obtain an operationally independent attack signature associated with the attack path. The computing service may store the operationally independent attack signature and metadata associated with the attack path. The computing service may output, to the devices associated with the autonomous pentesting operation of the target network, information associated with one or more previous autonomous pentesting operations associated with the operationally independent attack signature based on storing the operationally independent attack signature and the metadata associated with the attack path.

### BACKGROUND

In networking, penetration testing or “pentesting” refers to conducting security operations that simulate a cybersecurity attack in order to identify vulnerabilities in a network. The goal of pentesting is to mimic the actions of a malicious actor and discover loopholes or other vulnerabilities before they can be exploited. Pentesting may include techniques such as scanning for vulnerabilities, testing system configurations and security protocols, and attempting controlled attacks to evaluate defense mechanisms within a network. Network administrators can remediate vulnerabilities uncovered during pentesting to prevent malicious actors from compromising network security using those vulnerabilities. Practicing regular pentesting can aid in maintaining high security standards, protecting sensitive data, and ensuring the continuity of network services.

### SUMMARY

The described techniques relate to improved methods, systems, devices, and apparatuses that support operationally independent attack signatures in autonomous pentesting.

A method for of obtaining an operationally independent attack signature associated with an attack path of an autonomous pentesting operation of a target network by an apparatus is described. The method may include obtaining, from one or more devices associated with the autonomous pentesting operation of the target network, a sorted list of node adjacency information associated with the attack path of the autonomous pentesting operation of the target network, where the attack path represents an unauthorized access to one or more aspects of the target network, hashing the sorted list of node adjacency information in accordance with a hash function to obtain the operationally independent attack signature associated with the attack path, storing the operationally independent attack signature and metadata associated with the attack path of the target network in the autonomous pentesting operation of the target network, and outputting, to the one or more devices associated with the autonomous pentesting operation of the target network, information associated with one or more previous autonomous pentesting operations associated with the operationally independent attack signature based on storing the operationally independent attack signature and the metadata associated with the attack path of the target network in the autonomous pentesting operation.

An apparatus for of obtaining an operationally independent attack signature associated with an attack path of an autonomous pentesting operation of a target network is described. The apparatus may include one or more memories storing processor executable code, and one or more processors coupled with the one or more memories. The one or more processors may individually or collectively be operable to execute the code to cause the apparatus to obtain, from one or more devices associated with the autonomous pentesting operation of the target network, a sorted list of node adjacency information associated with the attack path of the autonomous pentesting operation of the target network, where the attack path represents an unauthorized access to one or more aspects of the target network, hash the sorted list of node adjacency information in accordance with a hash function to obtain the operationally independent attack signature associated with the attack path, store the operationally independent attack signature and metadata associated with the attack path of the target network in the autonomous pentesting operation of the target network, and output, to the one or more devices associated with the autonomous pentesting operation of the target network, information associated with one or more previous autonomous pentesting operations associated with the operationally independent attack signature based on storing the operationally independent attack signature and the metadata associated with the attack path of the target network in the autonomous pentesting operation.

Another apparatus for of obtaining an operationally independent attack signature associated with an attack path of an autonomous pentesting operation of a target network is described. The apparatus may include means for obtaining, from one or more devices associated with the autonomous pentesting operation of the target network, a sorted list of node adjacency information associated with the attack path of the autonomous pentesting operation of the target network, where the attack path represents an unauthorized access to one or more aspects of the target network, means for hashing the sorted list of node adjacency information in accordance with a hash function to obtain the operationally independent attack signature associated with the attack path, means for storing the operationally independent attack signature and metadata associated with the attack path of the target network in the autonomous pentesting operation of the target network, and means for outputting, to the one or more devices associated with the autonomous pentesting operation of the target network, information associated with one or more previous autonomous pentesting operations associated with the operationally independent attack signature based on storing the operationally independent attack signature and the metadata associated with the attack path of the target network in the autonomous pentesting operation.

A non-transitory computer-readable medium storing code for of obtaining an operationally independent attack signature associated with an attack path of an autonomous pentesting operation of a target network is described. The code may include instructions executable by one or more processors to obtain, from one or more devices associated with the autonomous pentesting operation of the target network, a sorted list of node adjacency information associated with the attack path of the autonomous pentesting operation of the target network, where the attack path represents an unauthorized access to one or more aspects of the target network, hash the sorted list of node adjacency information in accordance with a hash function to obtain the operationally independent attack signature associated with the attack path, store the operationally independent attack signature and metadata associated with the attack path of the target network in the autonomous pentesting operation of the target network, and output, to the one or more devices associated with the autonomous pentesting operation of the target network, information associated with one or more previous autonomous pentesting operations associated with the operationally independent attack signature based on storing the operationally independent attack signature and the metadata associated with the attack path of the target network in the autonomous pentesting operation.

### BRIEF DESCRIPTION OF THE DRAWINGS

FIG. 1 shows an example of a computing environment that supports operationally independent attack signatures in autonomous pentesting in accordance with aspects of the present disclosure.

FIG. 2 shows an example of an autonomous pentest map that supports operationally independent attack signatures in autonomous pentesting in accordance with aspects of the present disclosure.

FIG. 3 shows an example of a computing system that supports operationally independent attack signatures in autonomous pentesting in accordance with aspects of the present disclosure.

FIGS. 4 and 5 show examples of an attack path diagram that supports operationally independent attack signatures in autonomous pentesting in accordance with aspects of the present disclosure.

FIG. 6 shows a diagram of a system including a device that supports operationally independent attack signatures in autonomous pentesting in accordance with aspects of the present disclosure.

FIG. 7 shows a flowchart illustrating methods that support operationally independent attack signatures in autonomous pentesting in accordance with aspects of the present disclosure.

### DETAILED DESCRIPTION

Autonomous penetration testing (e.g., also referred to as “pentesting”) may be performed on a network or system and may output one or more attack paths that correspond to the operations performed during pentesting. An attack path may represent unauthorized access to the network. For example, an autonomous pentesting operation performed on a target network may utilize an autonomous pentesting agent to attempt to gain unauthorized access to one or more network assets of the target network. In some cases, such autonomous pentesting operations may have attack paths that list or show one or more operations (or actions) performed by the pentesting agent during the autonomous pentesting operation. In some examples, the one or more operations may be represented by nodes within an attack graph, which illustrates an order (e.g., sequential order) of actions executed by the autonomous pentesting agent. For example, a first node may represent the autonomous pentesting agent gaining access to a first asset of the target network, which is followed by a second note that represents the autonomous pentesting gaining access to or performing an action on a second asset of the target network after gaining access to the first asset. In some examples, users may search databases for pentesting operations based on metadata of the nodes within an attack graph. For example, a user may search and query operations using one or more text attributes, however, attack paths and graphs may depict relatively complex sets of data and relationships that are unable to be searched via text attributes. Further, such relationships may be illustrated via visual depictions or shapes of attack paths, where each shape indicates a set of specific set of actions performed by the pentest and corresponds to a type of network compromise or access gain by the pentest.

In accordance with the techniques of the present disclosure, an autonomous pentesting service may obtain an operationally independent attack signature associated with an attack path of an autonomous pentesting operation of a target network. An operationally independent attack signature refers to a signature or shape of an attack path that is dependent on the operations performed by the pentest according to the attack path. Different sets of operations performed by a pentest result in different attack paths and consequently, different attack signatures or shapes.

In some examples, the autonomous pentesting service may obtain, from one or more devices associated with the autonomous pentesting operation of the target network, a sorted list of node adjacency information associated with the attack path of the autonomous pentesting operation of the target network. The autonomous pentesting service may then hash the sorted list of node adjacency information in accordance with a hash function to obtain the operationally independent attack signature associated with the attack path and store the operationally independent attack signature and metadata associated with the attack path of the target network as part of the autonomous pentesting operation of the target network. In response, the autonomous pentesting service may output, to the one or more devices associated with the autonomous pentesting operation of the target network, information associated with one or more previous autonomous pentesting operations associated with the operationally independent attack signature.

In some examples, the information associated with one or more previous pentesting operations may be output in response to a request or search query from one or more users. In some cases, via the information, the autonomous pentesting service may output an indication of one or more tags associated with pentesting operations, an indication of a quantity of previous pentesting operations associated with the same operationally independent attack signature, an indication of mitigation techniques to prevent similar attack paths, or any combination thereof. By obtaining the information, users may be capable of identifying whether an attack path is relatively common, or unique, to determine whether mitigation actions can prevent the attack path among other types of security actions or operations. Further, the information may inform users on the vulnerabilities of networks and how to fix such vulnerabilities to improve and enhance the security of a target network.

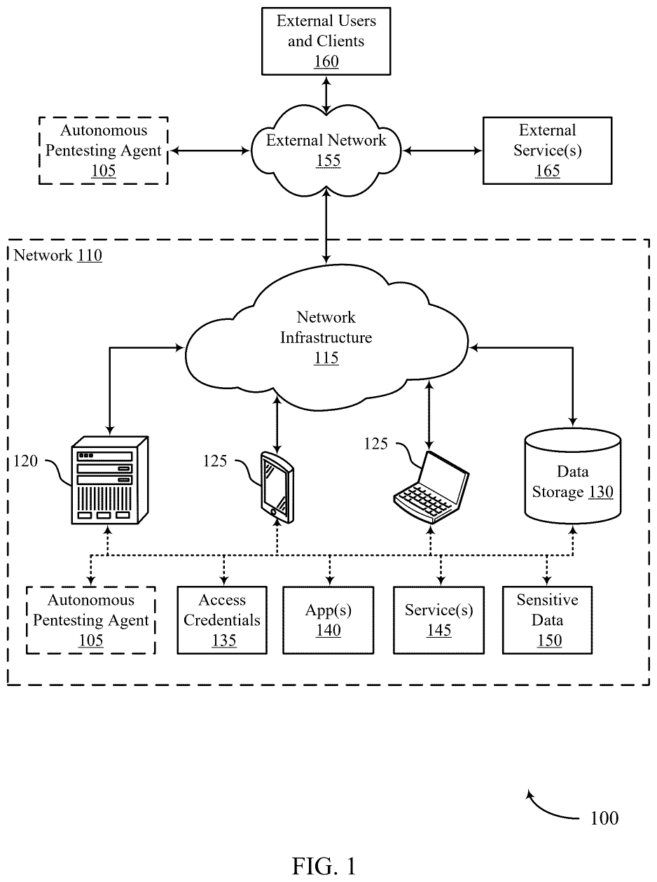

FIG. 1 illustrates an example of a computing environment 100 that supports operationally independent attack signatures in autonomous pentesting in accordance with aspects of the present disclosure. The computing environment 100 may include an autonomous pentesting agent 105 that performs an autonomous pentest of a network 110. The network 110 may include one or more devices or systems, such as a network infrastructure 115, server 120, computing devices 125, data storage 130, or any combination thereof. The devices or systems of the network 110 may be configured to access or provide various network information and services, such as access credentials 135, app(s) 140, service(s) 145, sensitive data 150, or any combination thereof.

The network 110 may allow the server 120, the computing devices 125, and the data storage 130 to communicate (e.g., exchange information) with one another. For example, the network infrastructure 115 may include any quantity of communications links and any quantity of hubs, bridges, routers, switches, ports, or other physical or logical network components that support communication between the server 120, computing devices 125, and data storage 130 of the network 110 as well as communication between the network 110 (e.g., the private network) and an external network 155 (e.g., the Internet). The network 110 may include aspects of one or more wired networks, one or more wireless networks (e.g., cellular networks), or any combination thereof. The network 110 may include aspects of one or more public networks or private networks, as well as secured or unsecured networks, or any combination thereof. For example, the network 110 may be an example of a private network that includes one or more public-facing or external assets that are accessible via an external network 155. As an example, the external network 155 may refer to the Internet, and users, such as external users and clients 160, may access the network 110 via the external network 155 through a website or application that is on the external network 155. For example, the external users and clients 160, the external service(s) 165, or both may access network information and services via the external network 155 (e.g., via the Internet), including the access credentials 135, app(s) 140, service(s) 145, and sensitive data 150.

The network 110 may be accessible via one or more hosts. For example, hosts may be examples of real or virtual machines that are connected to and capable of accessing the network 110. Real machines may refer to machines having or made up of hardware components including a central processing unit (CPU), memory, hard drive, or the like, such as physical or tangible computers or servers (e.g., the server 120, the computing devices 125, etc.). Virtual machines may refer to software within or running on a physical computer or server using portions of the CPU, memory, hard drive, or the like of the physical computer or server. A physical computer or server may include or support multiple virtual machines, such as multiple tenants (e.g., in a multi-tenant environment). The server 120 and the computing devices 125 may be examples of hosts. Hosts may communicate data with other devices within the network 110 and outside of the network (e.g., with devices in an external network 155). For example, the server 120 may send data to and receive data from one or more of the computing devices 125. Additionally, or alternatively, hosts may access resources of the network 110, including the access credentials 135, app(s) 140, service(s) 145, or sensitive data 150. As used herein, hosts may refer to web hosts, cloud hosts, virtual hosts, remote hosts, or the like.

Hosts may be examples of and include network assets. For example, a host may be an example of a type of network asset that has access to other network assets, such as applications, services, and resources. As used herein, network assets refer to machines that include network shares. For example, network assets may be examples of machines (e.g., real or virtual machines) that include shares of the network 110, such as file sharing systems. Network assets may be obtained and utilized by attackers to compromise the network 110. The server 120, the computing devices 125, the data storage 130, and the access credentials 135, app(s) 140, service(s) 145, and sensitive data 150 accessible via the devices and systems of the network 110 may all be examples of network assets. For example, physical devices (e.g., servers, computing devices, data storage, etc.) and systems may be considered network assets as well as information, apps, and services accessible through physical devices and systems of the network 110.

Hosts may store, provide, or implement access credentials 135, app(s) 140, service(s) 145, sensitive data 150, or any combination thereof. In some cases, computing devices 125 on the network may access the one or more assets (e.g., access credentials 135, app(s) 140, service(s) 145, sensitive data 150, etc.) via the server 120 (e.g., via a host). Additionally, or alternatively, computing devices 125 may locally store or otherwise access the one or more assets of the network 110. For example, users of the network 110 may access app(s) 140 and service(s) 145 via the computing devices 125 directly or indirectly (e.g., via a connection between the computing devices 125 and the server 120).

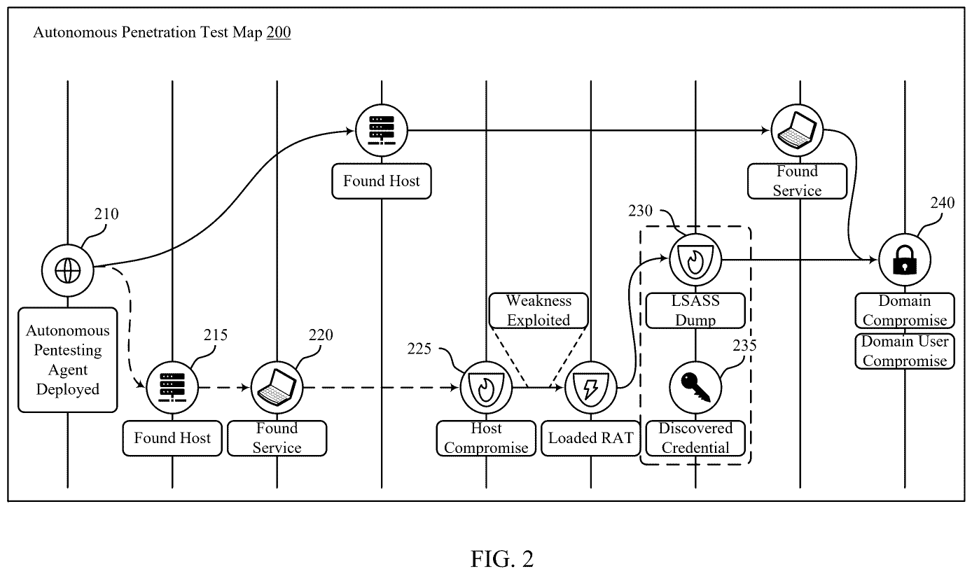

The autonomous pentesting agent 105 may perform a pentest of the network 110. As used herein, a penetration test or a “pentest” may refer to one or more security operations that simulate a cybersecurity attack in order to identify vulnerabilities in the network 110. The autonomous pentesting agent 105 may perform the pentest of the network 110 using one or more artificial intelligence (AI) models. For example, the autonomous pentesting agent 105 may be “autonomous,” as the autonomous pentesting agent 105 may perform the pentest without a requirement of hard-coding, user inputs, or the like and, instead, by using the one or more AI models. The autonomous pentesting agent 105 may identify, via the pentest, security vulnerabilities of the network 110. An example of an output of the pentest may be described in greater detail elsewhere herein, including with reference to FIG. 2.

The autonomous pentesting agent 105 may, via the one or more AI models, determine and implement an attack path for a pentest. For example, the autonomous pentesting agent 105 may identify or select an asset of the network 110 to attempt to access initially and, from that asset, another asset to attempt to access, and so on. In other words, the autonomous pentesting agent 105 may use the one or more AI models to mimic decisions of an attacker. The one or more AI models may output a targeted asset of the network 110 to be subject to an access attempt by the autonomous pentesting agent 105 based on inputs including context of various assets in the network 110. In other words, the one or more AI models may output targeted assets based on the relative position of assets within the network 110, asset types, downstream assets (e.g., accessible after or through accessing a targeted asset), or the like.

The one or more AI models may be trained using data of previous pentests of the network 110 or other networks. For example, an autonomous pentesting service that deploys the autonomous pentesting agent 105 may train one or more AI models used by the autonomous pentesting agent 105 using tactics, techniques, and procedures (TTPs) of attackers (e.g., human or automated pentests), autonomous pentests performed on the network 110 previously or on other networks, or both. The autonomous pentesting agent 105 may perform improved pentests after the one or more AI models are trained using previous pentests of the network 110. That is, as the autonomous pentesting agent 105 learns more about the network 110, the autonomous pentesting agent 105 may perform pentests with higher performance levels (e.g., higher accuracy, higher quantities of potential attack paths, etc.).

In some cases, the pentest may be internal or external to the network 110. For example, the autonomous pentesting agent 105 may be deployed at a host device of the network 110 (e.g., deployed to the server 120 or computing devices 125). In such examples, the autonomous pentesting agent 105 may perform the pentest as an internal user of the network 110. Such internal pentests may be indicative of or emulate internal security threats to the network, such as from employees of an organization or an attacker that has otherwise obtained access to the network 110 internally. Alternatively, the autonomous pentesting agent 105 may be deployed at the external network 155. For example, the autonomous pentesting agent 105 may perform the pentest as an external user of the network 110, such as by accessing external or public-facing assets of the network 110 on the external network 155.

By performing the pentest autonomously via the autonomous pentesting agent 105, techniques described herein may support improved performance related to speed, identification of security vulnerabilities, and provision of remediation measures. For example, the pentest, when performed autonomously using the autonomous pentesting agent 105, may support improved performance and, by extension, improved security of the network 110 against cybersecurity attacks relative to hard-coded (e.g., automated) or manual (e.g., human operated) pentests.

As described herein, in accordance with the techniques of the present disclosure, an autonomous pentesting agent 105 associated with an autonomous pentesting service may obtain an operationally independent attack signature associated with an attack path of an autonomous pentesting operation of a target network (e.g., the network 110). For example, users of the computing environment 100 may utilize the techniques of the present disclosure to search for attack paths and identify unique attack paths on the network 110. For example, a user may search for previous operations that are associated with a similar shape or operationally independent attack signature. In response, the user may obtain information that indicates that no previous pentesting operations or a relatively small quantity of pentesting operations are associated with the same operationally independent attack signature. Utilizing the information, the user may implement one or more mitigation techniques to reduce the security risk of the network 110. Moreover, the techniques of the present disclosure may decrease the time-consumption associated with such searching process and may thus reduce the delay in implementing the one or more mitigation techniques therefore reducing a duration of the network 110 being associated with one or more security risks.

FIG. 2 shows an example of an autonomous pentest map 200 that supports operationally independent attack signatures in autonomous pentesting in accordance with aspects of the present disclosure. The autonomous pentest map 200 may be an example of an output or result of an autonomous pentest performed by an autonomous pentesting agent, such as a pentest performed by the autonomous pentesting agent 105 in the network 110 as described with reference to FIG. 1. The autonomous pentest map 200 may illustrate and describe an example of events of a pentest, including operations performed by and information obtained by the autonomous pentesting agent.

The autonomous pentest map 200 may include one or more types of events. For example, the autonomous pentest map 200 may include deployment 210 (e.g., of the autonomous pentesting agent), host identification 215, service identification 220, host compromise 225, deployment of an attacker tool 230 (e.g., a remote access tool (RAT), credential identification 235, and access 240 (e.g., to a domain, a domain user, or both). The autonomous pentest map 200 includes one possible attack path including two attack branches that is generated based on an autonomous pentest. However, it is understood that any quantity of possible attack paths having any quantity of possible attack branches may be output from an autonomous pentest. In other words, the autonomous pentest map 200 may include one or more attack paths having one or more respective attack branches. In some cases, dozens, hundreds, or thousands of possible attack paths, branches, or both may be generated based on the autonomous pentest. Additionally, it is understood that while the autonomous pentest map 200 shown in FIG. 2 displays one example of an autonomous pentest for illustration, other maps including various different events, hosts, attack paths, and attack branches may result from various autonomous pentests.

In the example of the autonomous pentest map 200, the autonomous pentesting agent may identify an attack path having two attack branches. As used herein, attack “path” may be understood to refer to a series of events, set in motion by the autonomous pentest agent, that lead to a compromise of one or more components or assets of a network. Additionally, “branches” or “chains” of an attack path may refer to one or more events occurring simultaneously or in parallel that lead to the compromise. As an example, in a first attack branch of the autonomous pentest map 200, the autonomous pentesting agent may identify a host, identify a service, and compromise the host (e.g., through the service). On the compromised host, the autonomous pentesting agent may exploit a weakness identified on the service running on the host to load a RAT and remotely control the compromised host. The autonomous pentesting agent pay perform, via the RAT, a Local Security Authority Subsystem Service (LSASS) dump, allowing the autonomous pentesting agent to discover a credential. The autonomous pentesting agent may use the credential in a different branch of the attack path. For example, in a second attack branch of the autonomous pentest map 200, the autonomous pentesting agent may identify a host and, through the identified host, a service. The autonomous pentesting agent may use the discovered credentials (e.g., of the first attack branch) at the service (e.g., of the second attack branch to obtain access 240 to the domain, domain user, or both.

An autonomous pentesting service may display the autonomous pentest map 200 such that compromised assets may be identified and security measures may be put in place. In some cases, the autonomous pentesting service may provide mitigation recommendations according to the autonomous pentest map 200. As an example, the autonomous pentest map 200 may identify a particular host or service as a security vulnerability for a network by tracing the access 240 backwards to a host identification 215 event. Accordingly, the autonomous pentesting service may provide a mitigation recommendation to be applied to the host involved in the host identification 215 event, such as according to how the host was identified or how access was obtained to the host at the host compromise 225 event. Similarly, the autonomous pentesting service may provide a mitigation recommendation to be applied to the service involved in the service identification 220 event.

The autonomous pentesting service may support obtaining an operationally independent attack signature associated with an attack path of an autonomous pentesting operation of a target network (e.g., an attack path illustrated via the autonomous pentest map 200). In some cases, users may want to search or query for operations that generate an attack path. However, current systems may limit users to searching via text attributes.

To enable improved searching capabilities, in accordance with the techniques of the present disclosure, a service associated with an autonomous pentesting service may obtain, from one or more devices associated with the autonomous pentesting operation of the target network, a sorted list of node adjacency information associated with the attack path of the autonomous pentesting operation of the target network (e.g., the autonomous pentest map 200). Moreover, as described herein, the attack path may represent an unauthorized access to one or more aspects of the target network. The service may then hash the sorted list of node adjacency information in accordance with a hash function to obtain the operationally independent attack signature associated with the attack path and store the operationally independent attack signature and metadata associated with the attack path of the target network in the autonomous pentesting operation of the target network. In response, the service may output, to the one or more devices associated with the autonomous pentesting operation of the target network, information associated with one or more previous autonomous pentesting operations associated with the operationally independent attack signature. Therefore, the techniques of the present disclosure may enable users to obtain information about the autonomous pentest map 200 by searching for attack paths via the operationally independent attack signature of the attack path associated with the autonomous pentest map 200. Thus, users may utilize the information to increase the level of security of a network 110 with relatively less latency.

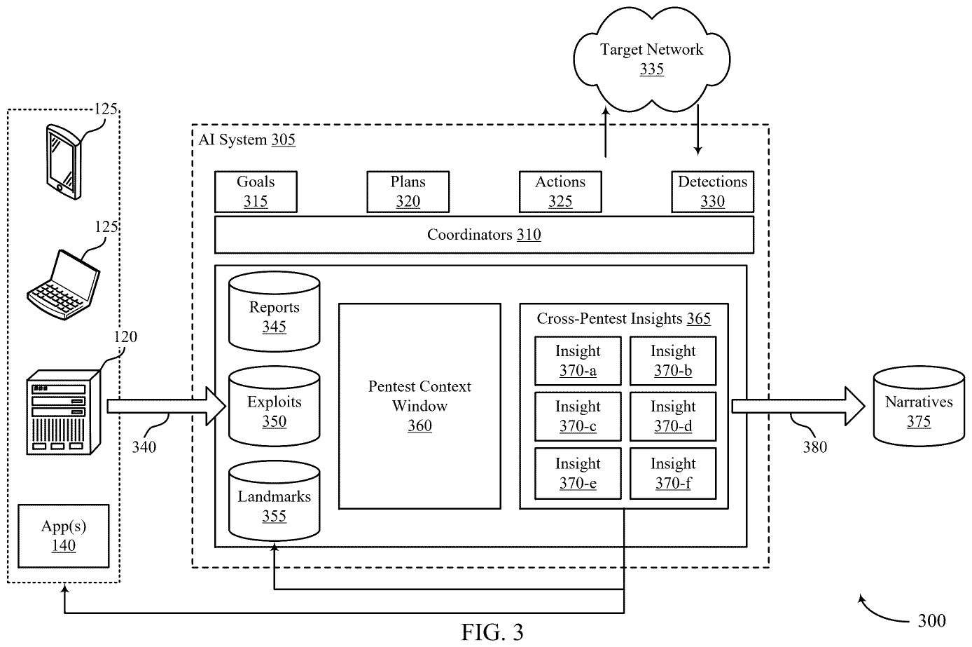

FIG. 3 shows an example of a computing environment 300 that supports operationally independent attack signatures in autonomous pentesting in accordance with aspects of the present disclosure. The computing environment 300 may implement or be implemented by the computing environment 100, the autonomous pentest map 200, or both. For example, the computing environment 300 may illustrate servers 120, computing devices 125, and app(s) 140 utilizing an AI system 305 to perform autonomous pentests.

In some examples, the AI system 305 may be a system designed to process data, learn from past experiences, and make determinations and predictions that mimic human cognitive functions. In some cases, the AI system 305 may implement or be implemented by one or more AI or machine learning (ML) models (e.g., AI/ML models). In some examples, an AI/ML model of the AI system 305 may be a supervised learning model configured to learn from labeled training data to generate predictions on inputs. In some other examples, an AI/ML model of the AI system 305 may be an unsupervised learning model that is configured to discover patterns in unlabeled data to generate predictions on inputs. In another example, the AI system 305 may implement reinforcement learning models that are configured to learn behaviors through trial-and-error (e.g., via experimentation). Additionally, or alternatively, the AI system 305 may implement neural networks (e.g., artificial neural networks (ANNs)) that include one or more layers configured to process information via a series of mathematical transformations.

Deep learning models may be a subset of neural networks designed and configured for tasks such as computer vision and natural language processing. In some examples, the AI system 305 may utilize a large language model (LLM) which utilizes a neural network architecture to process, understand, and generate natural language. For example, LLMs may be trained on a relatively large corpus of data (e.g., text data, image data, audio data, video data, among others) to perform natural language processing tasks such as text generation, translation, summarization, responding to natural language queries, data generation, or any combination thereof.

The AI system 305 may be an agentic AI system, meaning that the AI system 305 may act autonomously, at least for some operations, to achieve specified goals, make decisions, and take actions without direct human intervention (e.g., through the use of AI agents). In some cases, the AI system 305 may be an agentic AI system with limited human involvement where the AI system 305 may request human guidance or user input only in certain circumstances, such as if the AI system 305 is unable to make a decision or perform a subsequent operation. Further, the AI system 305 may use one or more AI/ML models to set and pursue goals 315 without those goals 315 being specifically defined by human input to the AI system 305. The AI system 305 may further generate plans 320 and execute sequences of actions 325 to achieve those goals 315 and adapt future behavior in accordance with real-time observations and feedback about the effectiveness of the actions 325 to achieve the desired outcomes or meet targets.

For example, in some cases, utilizing one or more AI/ML models, the AI system 305 may interface with one or more coordinators 310 that coordinate goals 315 and plans 320, actions 325, and detections 330 for achieving the goals 315. For example, for autonomous pentesting, the goals 315 of the AI system 305 may be to obtain access to data stored within a network 110, compromise (such as by obtain unauthorized administrative access or deploying unauthorized software to) a domain or a network asset of the network 110, or any combination thereof. To obtain the goals 315, the AI system 305 may generate one or more plans 320 that are based on actions 325 and detections 330. For example, to determine a next best action within a defined set of guardrails or instructions, the AI system 305 may generate a plan 320 that can include an action 325 to invoke (e.g., execute) one or more commands on a target network 335 to obtain a detection 330 from the target network 335.

In some examples, the target network may include one or more network assets such as servers 120, computing devices 125, data storages 130, app(s) 140, or any combination thereof. Further, obtaining a detection 330 from the target network 335 may include the AI system 305 retrieving telemetry data from the one or more network assets of the target network 335. In some cases, telemetry data obtained from the target network 335 may include logs, traces, metrics, events, or any combination thereof from the one or more network assets of the target network 335. For example, a detection 330 may include some data that is obtained from the target network 335 via an autonomous pentest that aids the AI system 305 in achieving the goals 315. In one example, the detection 330 may include an autonomous pentest obtaining a credential that is used to gain unauthorized access to a network asset, which may be an example of one of the goals 315. In another example, a detection 330 may be the autonomous pentest detecting a set of patterns of events indicated within logs of the target network 335, which may be utilized for achieving a respective goal 315. For example, a goal 315 may be to perform a successful credential compromise attack to gain unauthorized access to a network asset and a detection 330 may indicate information to aid an autonomous pentesting agent in performing the credential compromise attack.

In some examples, the AI system 305 may also interface with the one or more coordinators 310 to perform autonomous pentests as described elsewhere herein, such as with reference to FIGS. 1 and 2. When performing autonomous pentests, the AI system 305 may collect and store a relatively large quantity (such as thousands, millions, or billions) of training data points or tokens for the AI system 305 to perform subsequent autonomous pentests. For example, each action 325 (e.g., command) executed via the AI system 305 may result in a collection of a relatively large quantity of training data points that indicate whether the action 325 succeeded or failed, why the action 325 succeeded or failed, which software, policies, or tools were used to execute the action 325 thar resulted in the action 325 succeeding or failing, or any combination thereof. Therefore, the AI system 305 may continuously obtain and update the training data used for training AI/ML models and perform reinforcement learning using collective intelligent to improve the weights and training of the AI/ML models.

In some examples, the training data for the AI system 305 may include telemetry data obtained from the target network 335, data obtained from servers 120, computing devices 125, and app(s) 140 via a developer pipeline 340, or both. In some cases, the training data may include indications of reports 345, exploits 350, and landmarks 355. A report 345 may indicate outputs or artifacts generated by the AI system 305 to document the discoveries, vulnerabilities, and results of an autonomous pentest. An exploit 350 may indicate the tools, techniques, operations, programs, code, and the like utilized by the AI system 305 to perform an autonomous pentest. A landmark 355 may indicate a point or marker within a network (e.g., the target network 335) to assist the AI system 305 to navigate and map a target environment during an autonomous pentest.

In some examples, the AI system 305 may obtain the reports 345, exploits 350, and landmarks 355 based on performing one or more autonomous pentests. In another example, one or more users (e.g., developers) may manually generate the reports 345, exploits 350, and landmarks 355 for training the AI system 305. In such cases, the one or more users may generate the data for the reports 345, exploits 350, and landmarks 355 and label the data for the AI system 305. Additionally, or alternatively, one or more users may utilize an LLM to generate the reports 345, exploits 350, and landmarks 355. For example, a user may prompt an LLM to generate the reports 345, exploits 350, and landmarks 355 by proving the LLM with a set of input parameters that indicate a scope, objectives, and constraints of an autonomous pentest. In some examples, the LLM prompt to generate the reports 345, exploits 350, and landmarks 355 may be a natural language prompt that includes instructions that indicates characteristics of the target network 335, testing protocols, compliance requirements, or any combination thereof. The LLM may then process the prompt and generate the reports 345, exploits 350, and landmarks 355 for training the AI system 305.

Utilizing the reports 345, exploits 350, and landmarks 355, the AI system 305 may perform one or more autonomous pentests by maintaining awareness of the current testing state and progress through a pentest context window 360. The pentest context window 360 may processes information about ongoing pentests, including successfully exploited vulnerabilities, accessed systems and data, attempted but failed exploit paths, among others.

In some examples, the AI system 305 may analyze contextual information obtained from performing autonomous pentests to generate cross-pentest insights 365 that can be applied across multiple pentesting operations. For example, as a result of training the AI system 305, one or more autonomous pentests, or both, the AI system 305 may generate a set of cross-pentest insights 365 that indicates one or more insights 370 (e.g., an insight 370-a, an insight 370-b, an insight 370-c, an insight 370-d, an insight 3770-e, and an insight 370-f). For example, the insight 370-a may indicate patterns of vulnerable default configurations in commonly used enterprise software. In some other examples, the insight 370-b may indicate how compromised low-privilege user credentials can be leveraged to eventually gain domain admin access through privilege escalation techniques. Further, the insight 370-c and the insight 370-d may indicate common pathways where initial network access can lead to sensitive data exposure, such as finding unencrypted password files or accessing improperly secured cloud storage buckets. The insight 370-e may indicate recurring vulnerabilities in network segmentation that allow lateral movement between supposedly isolated systems. Additionally, or alternatively, the insight 370-f may indicate patterns where seemingly low-risk misconfigurations can be chained together to achieve relatively significant network compromise. Therefore, the cross-pentest insights 365 may indicate one or more insights 370 that represent patterns and vulnerabilities that occur across different networks and testing scenarios, helping organizations better understand systemic security weaknesses that need to be addressed. For example, the cross-pentest insights 365 may be added as landmarks 355 for further training the AI system 305 to perform autonomous pentests.

In some examples, the cross-pentest insights 365 may be displayed to computing devices 125, app(s) 140, or both to enable users to view and analyze the cross-pentest insights 365 to generate additional TTPs configured to achieve the goals 315 of the AI system 305. To display the cross-pentest insights 365 to one or more users, the AI system 305 may generate one or more narratives 375 that indicate the insights 370 obtained in response to one or more autonomous pentests. In some examples, to generate the one or more narratives 375, the AI system 305 may output (e.g., transmit) the cross-pentest insights 365 via a pipeline 380 connected to a separate AI/ML model (e.g., an LLM). For example, the AI system 305 may output the cross-pentest insights 365 to an LLM that is configured to generate the narratives 375 (e.g., the LLM is finetuned for text generation based on an input of the insights 370). In some cases, the narratives 375 may indicate detailed security postures for organizations, companies, tenants, users, groups of users, or any combination thereof. For example, a narrative 375 may be a compliance narrative that indicates one or more insights 370 about the security compliance of a network 110. In another example, a narrative 375 may be a presentation for a company or organization that indicates the one or more vulnerabilities in a network 110 associated with the company or organization. For example, the presentation can indicate the cross-pentest insights 365 obtained from performing one or more autonomous pentests on the network 110 associated with the company or organization (e.g., the target network 335).

In accordance with the techniques of the present disclosure, an autonomous pentesting service may utilize the AI system 305 to obtain an operationally independent attack signature associated with an attack path of an autonomous pentesting operation of a target network 335. For example, the autonomous pentesting service may utilize a sorted list of node adjacency information to obtain an operationally independent attack variant signature and an operationally independent attack signature associated with the attack path of an autonomous pentesting operation. Further, the autonomous pentesting service may utilize the AI system 305 to compare an autonomous pentesting operation to one or more previous autonomous pentesting operations. For example, the one or more cross-pentesting insights 365 may determine if a shape of attack path occurs multiple times via a set of autonomous pentesting operations. Thus, the narratives 375 may indicate information associated with one or more previous autonomous pentesting operations associated with the operationally independent attack signature. In some cases, the narratives 375 may indicate whether an operationally independent attack signature is relatively common or uncommon, one or more mitigation techniques that can be implemented to improve the security of the target network 335.

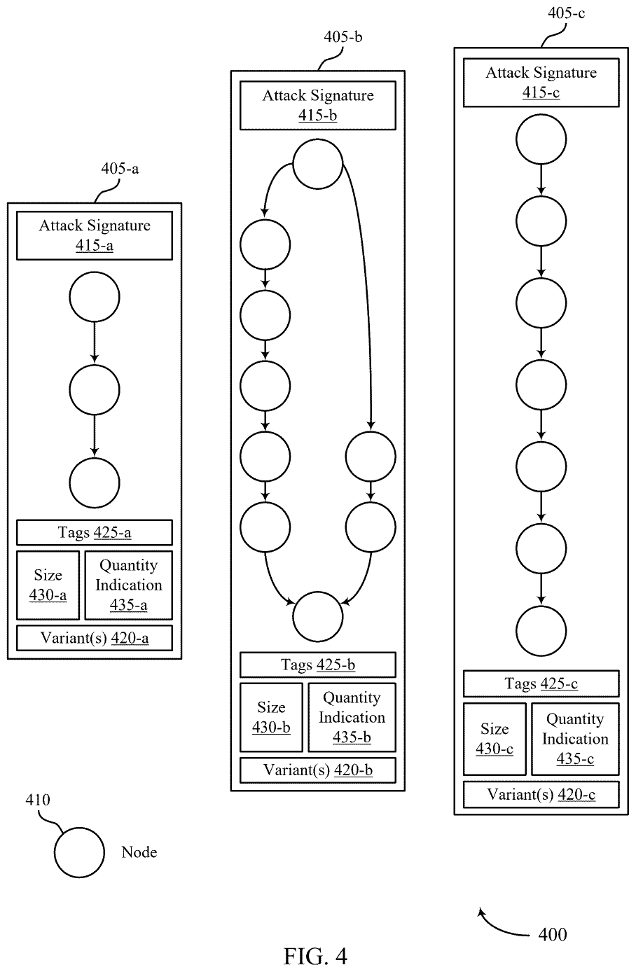

FIG. 4 shows an example of attack path diagrams 400 that supports operationally independent attack signatures in autonomous pentesting in accordance with aspects of the present disclosure. The attack path diagrams 400 may implement or be implemented by the computing environment 100, the autonomous pentest map 200, the computing environment 300, or any combination thereof. For example, the attack path diagrams 400 may illustrate one or more attack paths 405 (e.g., an attack path 405-a, an attack path 405-b, and an attack path 405-c) each associated with a different autonomous pentesting operation and a different operationally independent attack signature. Further, each attack path 405 may include one or more nodes 410.

In some examples, a computing service associated with an autonomous pentesting service may obtain, from one or more devices associated with the autonomous pentesting operation of the target network, a sorted list of node 410 adjacency information associated with an attack path 405 of the autonomous pentesting operation of the target network. In some examples, the computing service may be a part of the autonomous pentesting service or separate from the autonomous pentesting service. As used herein, attack “path” may be understood to refer to a series of events or actions, set in motion by the autonomous pentest agent, that lead to a compromise of one or more components or assets of a network. Such events or actions may be illustrated by the one or more nodes 410 of an attack path 405. For example, an autonomous pentesting agent may perform an autonomous pentesting operation that results in one or more compromises that can be illustrated via an attack path 405 (e.g., the attack path 405-a, the attack path 405-b, the attack path 405-c, or any combination thereof).

Moreover, the attack path 405 may represent an unauthorized access to one or more aspects of the target network. Further, the attack path 405 may include one or more nodes 410 that represent the actions of an autonomous pentesting operation that result in the unauthorized access to the one or more aspects of the target network. Additionally, or alternatively, the one or more nodes 410 of an attack path 405 may represent the actions associated with the unauthorized access to the one or more aspects of the target network.

In some examples, an attack path 405 may include one or more nodes 410 that are within a respective shape. In some cases, the shape and structure of the one or more nodes 410 of a respective attach graph may be indicated via the sorted list of node adjacency information obtained from the one or more devices associated with a respective autonomous pentesting operation. To generate the sorted list of node adjacency information, the autonomous pentesting service may calculate a list of node 410 adjacency information for a pentesting operation from post-extract/transform/load (ETL) operation data. The autonomous pentesting service may then sort the list of node 410 adjacency information to generate the sorted list of node 410 adjacency information that is output to the computing service. By sorting the list of node 410 adjacency information, the autonomous pentesting service may ensure that a textual representation of the respective attack graph is relatively isomorphic (e.g., having a similar structure or shape). Therefore, when the computing service hashes a respective attack path 405, two different attack paths 405 with the same structure and different metadata should have the same hash to ensure consistency between different attack vectors or operations with the same attack graph structure.

Moreover, the sorted list of node adjacency information may include relatively minimal information such as adjacency information and node type data. In some examples, the node type data may indicate a type of event or action performed via an autonomous pentesting operation in the attack path 405. For example, the pentesting attack paths may lead to compromise event(s). Compromising any of the network assets within a given attack path may lead to a compromise event in that attack path. The compromise events may be examples of the compromise events described with reference to FIG. 2. For example, the compromise events may be examples of host compromise, discovered credentials, deployment of attacker tools, domain compromise, domain user compromise, root access being obtained, access to a secured shell (SSH), a file transfer protocol (FTP), or both to transfer files stored in the network 110, or the like.

After obtaining the sorted list of node 410 adjacency information, the computing service hash the sorted list of node 410 adjacency information in accordance with a hash function to obtain an operationally independent attack signature 415 (e.g., an operationally independent attack signature 415-a, an operationally independent attack signature 415-b, or an operationally independent attack signature 415-c) associated with an attack path 405 (e.g., the attack path 405-a, the attack path 405-b, the attack path 405-c). In some examples, hashing the sorted list of node 410 adjacency information may include first hashing sorted list of node 410 adjacency information in accordance with the hash function to obtain an operationally independent attack variant signature that corresponds to the sorted list of node 410 adjacency information associated with the attack path. The computing service may then transform the sorted list of node 410 adjacency information into a generic sorted list of node 410 adjacency information by removing node 410 subtype information from the sorted list of node 410 adjacency information. The computing service may then hash the generic sorted list of node 410 adjacency information to obtain the operationally independent attack signature 415 of an attack path 405. Moreover, hashing the sorted list of node 410 adjacency information to obtain the operationally independent attack signature 415 may be separate from hashing the sorted list of node 410 adjacency information to obtain the operationally independent attack variant signature. That is, the computing service may first hash the sorted list of node 410 adjacency information to obtain a first signature (e.g., an operationally independent attack variant signature) that identifies the respective attack path 405 and associated metadata and then hash a generic sorted list of node 410 adjacency information that is stripped of node subtype information to obtain a second signature (e.g., an operationally independent attack signature 415) identifying the shape of the respective attack path 405. Moreover, the operationally independent attack signature 415 of an attack path 405 may not be unique to a specific autonomous pentesting operation as many pentesting operations may have impact attack graphs with an identical shape and node types.

In some examples, one or more attack paths 405 associated with a same shape as indicated via the same operationally independent attack signature 415 may be referred to as variants 420. Each respective variant 420 of an attack path 405 (e.g., variants 420-a of the attack path 405-a, variants 420-b of the attack path 405-b, and variants 420-c of the attack path 405-c) associated with the same operationally independent attack signature 415 may each have a separate operationally independent attack variant signature to represent the metadata of a respective pentesting operation that results in generation of the attack path 405. Thus, the computing service may generate signatures for each respective attack path 405 along with signatures for a shape or structure of each respective attack path 405. Moreover, the operationally independent attack signature 415 of an attack path 405 may be associated with a node 410 structure of the attack path 405 and a node 410 type of the attack path 405 and the operationally independent attack variant signature may be associated with the node 410 structure of the attack path 405, the node 410 type of the attack path 405, and the node 410 subtype information. Additionally, or alternatively, the computing service may generate one or more tags 425 for each respective attack path 405 (e.g., tags 425-a for the attack path 405-a, tags 425-b for the attack path 405-b, and tags 425-c for the attack path 405-c). For example, the computing service may generate text tags associated with the metadata of an attack path 405 and add the text tags to information associated with a respective operationally independent attack signature 415 of a respective attack path 405.

Once the operationally independent attack signatures 415 and operationally independent attack variant signatures for respective attack paths 405 are obtained, the computing service may store the operationally independent attack signatures 415 and operationally independent attack signatures for each respective attack path 405 (e.g., the attack path 405-a, the attack path 405-b, and the attack path 405-c). For example, the computing service may store the operationally independent attack signature 415 and metadata associated with the respective attack path 405 of the target network in the autonomous pentesting operation of the target network. In some cases, the computing service may store both the operationally independent attack signature 415 and the operationally independent attack variant signature of a respective attack path 405 along with the metadata associated with the respective attack path 405. In some other cases, the computing service may store the signatures and metadata associated with the attack path 405 separately. In some examples, storing the signatures and metadata separately may include storing the operationally independent attack signature 415 of an attack path 405, the metadata of the attack path 405, and the operationally independent attack variant signature in any combination. For example, the operationally independent attack signature 415 may be stored with the metadata and the operationally independent attack variant signature is stored separately, the operationally independent attack variant signature may be stored with the metadata and the operationally independent attack signature 415 is stored separately, the operationally independent attack signature 415 and the operationally independent attack variant signature may be stored together and the metadata is stored separately, or the operationally independent attack signature 415, the operationally independent attack variant signature, and the metadata may each be stored separately.

In some other cases, the computing service may store pairs of sorted lists of node 410 adjacency information and operationally independent attack signatures 415 together to enable the autonomous pentesting service to generate a list of all known operationally independent attack signatures 415 (e.g., a list of all known attack path 405 shapes or structures). Using the list, data analytics and queries of attack paths 405 and pentesting operations may be performed. In some examples, storing the operationally independent attack signatures 415 and operationally independent attack variant signatures of attack paths 405 may enable the autonomous pentesting service the capability to track for similar attack paths 405 in subsequent pentesting operations. Moreover, in some cases, an operationally independent attack signature 415 may be referred to as a “species” of attack paths 405 or pentesting operations that each have the same shape or structure and an operationally independent attack variant signature may be referred to as a “genus” of attack paths 405 or pentesting operations that have the same shape or structure but different metadata.

In some examples, as illustrated herein, the autonomous pentesting operations associated with the attack path 405-a, the attack path 405-b, and the attack path 405-c may represent different attack paths 405 of different structures or shapes. As such, the attack paths 405 may each be associated with a different operationally independent attack signature 415 and a different list of node 410 adjacency information and sorted list of node 410 adjacency information. For example, a first attack path 405 (e.g., the attack path 405-a) may be associated with a first autonomous pentesting operation that results in a domain compromise via injected credentials. In some examples, the attack path 405-a may have a first node 410 to represent an initiation of the autonomous pentesting operation, a second node 410 may represent an injected credential, and a third node 410 may represent a domain compromise.

That is, after the autonomous pentesting operation is initiated, the autonomous pentesting service may use a compromised credential to gain access to a target network which results in a domain compromise. In such examples, a list of node 410 adjacency information may be: first node 410 (initiation node 410)->second node 410 (injected credential node 410); and second node 410->third node 410 (domain compromise node 410). Further, the sorted list of node 410 adjacency information may be: injected credential node 410->domain compromise node 410; and initiation node 410->injected credential node 410. The computing service may then hash the sorted list of node 410 adjacency information into the operationally independent attack signature 415-a and the operationally independent attack variant signature and store the signatures along with the corresponding metadata. Additionally, or alternatively, the computing service may also compute a size indicator 430 (e.g., a size indicator 430-a) for the attack path 405-a. The size indicator 430-a may indicate that the attack path 405-a has three nodes 410. Moreover, the computing service may compute a quantity indication 435 (e.g., a quantity indication 435-a) that indicates a quantity of variants 420 (e.g., variant attack paths 405 with the same operationally independent attack signature 415 and different operationally independent attack variant signatures).

In another example, an attack path 405 (e.g., the attack path 405-b) may be represent an autonomous pentesting operation that results in an autonomous pentesting agent gaining read/write access to a server message block (SMB) of a network 110. In some cases, the attack path 405-b may include a first branch and a second branch that both start with an initiation node 410 (e.g., a node 410 to indicate an initiation of an autonomous pentesting operation). Following the initiation node 410 of the attack path 405-b, the first branch may include a first node 410 that represents a first injected credential node 410, a second node 410 that represents a domain admin compromise node 410, a third node 410 that represents a RAT installation node 410, a fourth node 410 that represents a vulnerability identification node 410, and a fifth node 410 that represents a local admin compromise node 410. The second branch may include a first node 410 that represents a second injected credential node 410 and a second node 410 that represents a domain user compromise node 410. Further, each injected credential node 410 may be associated with a different injection credential. Moreover, both the first branch and the second branch of the attack path 405-b may both have a final node 410 that is an access node 410 representing access to a file listing of an SMB.

In such examples, the list of node 410 adjacency information may be the initiation node 410 and then an ordered listing of the nodes 410 in the first branch of the attack path 405-b followed by the initiation node 410 and an ordered listing of the nodes 410 in the second branch of the attack path 405-b. Further, the sorted list of node 410 adjacency information be: the domain administer compromise node 410->the RAT installation node 410; the domain user compromise node 410->the access node 410; the first injected credential node 410->the domain admin compromise node 410; the second injected credential node 410->the domain user compromise node 410; the local admin compromise node 410->the access node 410; the initiation node 410->the first injected credential node 410; the initiation node 410->the second injected credential node 410; the RAT installation node 410->the vulnerability identification node 410; and the vulnerability identification node 410->the local admin compromise node 410. Using the sorted list of node 410 adjacency information, the computing service may hash the sorted list of node 410 adjacency information to obtain the operationally independent attack signature 415-b along with a operationally independent attack variant signature and store the signatures along with the corresponding metadata. Additionally, or alternatively, the computing service may also compute a size indicator 430 (e.g., a size indicator 430-b) for the attack path 405-b. The size indicator 430-a may indicate that the attack path 405-a has a length of seven nodes 410 and a quantity of nine nodes 410. Moreover, the computing service may compute a quantity indication 435 (e.g., a quantity indication 435-b) that indicates a quantity of variants 420 (e.g., variant attack paths 405 with the same operationally independent attack signature 415 and different operationally independent attack variant signatures).

In another example, the attack path 405-c may represent the left side of the attack path 405-b (e.g., the first branch of the attack path 405-b). In such examples, the list of node 410 adjacency information for the attack path 405-c may be an initiation node 410 followed by an ordered listing of the nodes 410 in the nodes 410 in the attack path 405-c. Further, the sorted list of node 410 adjacency information may be: an domain administer compromise node 410->a RAT installation node 410; an injected credential node 410->a domain admin compromise node 410; a local admin compromise node 410->an access node 410; ab initiation node 410->the injected credential node 410; the RAT installation node 410->a vulnerability identification node 410; and the vulnerability identification node 410->the local admin compromise node 410. Using the sorted list of node 410 adjacency information, the computing service may hash the sorted list of node 410 adjacency information to obtain the operationally independent attack signature 415-c along with a operationally independent attack variant signature and store the signatures along with the corresponding metadata. Additionally, or alternatively, the computing service may also compute a size indicator 430 (e.g., a size indicator 430-c) for the attack path 405-c. The size indicator 430-a may indicate that the attack path 405-c has a quantity of and a length of seven nodes 410. Moreover, the computing service may compute a quantity indication 435 (e.g., a quantity indication 435-c) that indicates a quantity of variants 420 (e.g., variant attack paths 405 with the same operationally independent attack signature 415 and different operationally independent attack variant signatures).

Further, based on storing the operationally independent attack signature 415 and the metadata associated with a respective attack path 405 of the target network in the autonomous pentesting operation, the computing service may output, to the one or more devices associated with the autonomous pentesting operation of the target network, information associated with one or more previous autonomous pentesting operations associated with the operationally independent attack signature 415. In some examples, the computing service may receive, from the one or more devices associated with the autonomous pentesting operation, a request for the information via a search query or a search request. To enable searching of attack paths via lists of node 410 adjacency information or operationally independent attack signatures 415, the computing service may establish an application programming interface (API) to interact with and respond to queries from the autonomous pentesting service. In some examples, via the API, users or devices associated with an autonomous pentesting service (e.g., the autonomous pentesting service that executes the autonomous pentesting operation), may request for information associated with attack paths 405 with an operationally independent attack signatures 415 that are similar to a respective attack path 405 with a respective operationally independent attack signature 415.

In some cases, to request for such information, users or devices may transmit text-based searches to search for operationally independent attack signatures 415 that are associated with the same tags 425. For example, the attack path 405-a may be associated with a first tag 425 and a second tag 425, the attack path 405-b may be associated with the first tag 425 and a third tag 425, and the attack path 405-c may be associated with the second tag 425 and a fourth tag 425. Thus, the computing service may respond to a request for attack paths 405 and corresponding operationally independent attack signatures 415 that are associated with the first tag 425 with an indication of the operationally independent attack signature 415-a of the attack path 405-a and the operationally independent attack signature 415-b of the attack path 405-b. Similarly, the computing service may respond to a request for attack paths 405 and corresponding operationally independent attack signatures 415 associated with the fourth tag 425 with an indication of the operationally independent attack signature 415-c of the attack path 405-c.

In some other cases, the computing service may receive JavaScript object notation (JSON)-based searches, structural-based searches, graphical-based searches, or any combination thereof. For example, the computing service may receive a search request that indicates a request to obtain an indication of one or more attack paths 405 and corresponding operationally independent attack signatures 415 that each have a respective node 410 that has a respective adjacency to a respective type of node 410. Additionally, or alternatively, when responding to such requests, the computing service may respond with indications of attack paths 405 and corresponding operationally independent attack signatures 415 that did not originate from pentesting operations. For example, the computing service may have access to testing data, research data, or other types of data that can be used as a source for a response to a request.

Further, when responding to requests, the computing service may ensure anonymity across pentesting operations. For example, the autonomous pentesting service may be a multi-tenant service that performs pentest operations for multiple different tenants (e.g., organizations, companies, groups of users, and the like). Thus, the autonomous pentesting service and the computing service may have to prevent data exposure between tenants. In some cases, to prevent data exposures, the computing service may only respond with operationally independent attack signatures 415 for attack paths 405 associated with different tenants. For example, the operationally independent attack signature 415 just indicates a structure of nodes 410 and does not indicate any node 410 subtype information. Moreover, enabling users with the capability of obtaining information associated with operationally independent attack signatures 415 while preserving the anonymity across pentesting operationsmay the computing service the capability to generate and enrich operationally independent attack signatures 415 and operationally independent attack variant signatures with previously generated information, suggested mitigation steps, and the like.

In another example, the computing service may indicate one or more metrics associated with a respective operationally independent attack signature 415 of a respective attack path 405. For example, in response to a request, the computing service may include the size indicator 430 and the quantity indication 435 of the respective attack path 405 in response to a request. Thus, a user may be capable of performing addition analytics and determinations utilizing the information.

In some cases, the computing service may enable users to search the autonomous pentesting service via one or more advanced searching functions. For example, the computing service may obtain, from the one or more devices associated with the autonomous pentesting operation of the target network, a request for a respective operationally independent attack signature 415 associated with a respective sorted list of node 410 adjacency information. In some cases, the request may include an indication of the sorted list of node 410 adjacency information, thus the computing service may obtain the sorted list of node 410 adjacency information in response to the request. If a corresponding the operationally independent attack signature 415 exists within the computing service, the computing service may return (e.g., output), to the one or more devices associated with the autonomous pentesting operation of the target network, the operationally independent attack signature 415 associated with the sorted list of node 410 adjacency information in response to the request. In some other cases, if the computing service does not have an operationally independent attack signature 415 associated with the sorted list of node 410 adjacency information, the computing service may generate the corresponding operationally independent attack signature, store the signature, and return (e.g., output) the signature to the one or more devices. Thus, hashing the sorted list of node 410 adjacency information and storing the operationally independent attack signature 415 in response to obtaining the sorted list of node 410 adjacency information may be based on an existence of the operationally independent attack signature 415.

In another example, the computing service may obtain, from the one or more devices associated with the autonomous pentesting operation of the target network, a request for a respective sorted list of node 410 adjacency information that is associated with a respective operationally independent attack signature 415. Further, the request may include an indication of the respective operationally independent attack signature 415. In response, the computing service may determine if a mapping between the provided respective operationally independent attack signature 415 exists within a store of the computing service. If a mapping does exist, the computing service may return (e.g., output), to the one or more devices associated with the autonomous pentesting operation of the target network, the respective sorted list of node 410 adjacency information that is associated with the respective operationally independent attack signature 415 in response to the request.

In some examples, the computing service may also obtain, from the one or more devices associated with the autonomous pentesting operation of the target network, a request for one or more operationally independent attack signatures 415 associated with the one or more previous autonomous pentesting operations that satisfy a similarity threshold with a respective operationally independent attack signature 415 associated with a respective attack path 405. Further, the request may include an indication of the respective operationally independent attack signatures 415 and the similarity threshold. For example, the computing service, the autonomous pentesting service, or both, may generate a similarity score between the attack paths 405. In such cases, a similarity score between the attack path 405-a and the attack path 405-b or the attack path 405-c may be relatively low and a similarity score between the attack path 405-b and the attack path 405-c may be relatively high. In some examples, such similarity scores may be returned to users via one or more searches. For example, in response to the request and if the respective operationally independent attack signature 415 exists, the computing service may return (e.g., output), to the one or more devices associated with the autonomous pentesting operation of the target network via the information associated with the one or more previous autonomous pentesting operations, an indication of the one or more operationally independent attack signatures 415 associated with the one or more previous autonomous pentesting operations that satisfy the similarity threshold with the respective operationally independent attack signature 415. Moreover, the computing service may output the indication via the information based on obtaining the request.

In some other examples, the computing service may obtain, from the one or more devices associated with the autonomous pentesting operation of the target network, a request for one or more operationally independent attack signatures 415 associated with the one or more previous autonomous pentesting operations that satisfy a similarity threshold with the sorted list of node 410 adjacency information associated with a respective attack path 405. Further, the request may include an indication of the one or more sorted lists of node 410 adjacency information and the similarity threshold. In response, the computing service may output, to the one or more devices associated with the autonomous pentesting operation of the target network via the information associated with the one or more previous autonomous pentesting operations, an indication of the one or more operationally independent attack signatures 415 associated with the one or more previous autonomous pentesting operations that satisfy the similarity threshold. Moreover, the computing service may output the indication via the information based on obtaining the request.

Additionally, or alternatively, in response to a search request, the computing service may prefetch and output a representation of other similar operationally independent attack signatures 415 that are similar to a respective operationally independent attack signature 415 or sorted list of node 410 adjacency information. For example, the computing service may utilize an AI system (e.g., the AI system 305 described with reference to FIG. 3) to determine additional operationally independent attack signatures 415 that may be relevant or interesting to a user or device associated with the search request.

In some examples, to enable such advanced searching, the data associated with each respective operationally independent attack signature 415 and data associated with each respective pentesting operation may be stored at the computing service, the autonomous pentesting service, or both. Such storage may enable the autonomous pentesting service the capability to provide advanced searching functionalities via a user interface (e.g., a portal) of the autonomous pentesting service. In some other examples, in addition to storing the mapping for operationally independent attack signatures 415, the computing service may also store pentesting operation to operationally independent attack signature 415 mapping data to enable the capability for advanced search functionality for internal use. Thus, since the sorted list of node 410 adjacency information may include node 410 type information, users or devices may be capable of performing fuzzy searches to identify previous autonomous pentesting operations with any combination of node. A fuzzy search may be a type of search that finds results that are similar to a search query even if an exact match is not found, there is a misspelling in the search query, or there are variations that are close but not an exact match to the search query. For example, a user may output a search query to request for information associated with attack paths 405 and corresponding operationally independent attack signatures 415 associated with one or more previous pentesting operations that identify a first vulnerability and a second vulnerability when a first credential is injected as part of the autonomous pentesting operation (e.g., FIND vuln1 AND vuln2 AND injected_credential).

In some examples, when outputting the information to the one or more devices in response to a search query, the computing service may indicate portions of the metadata associated with an attack path 405. In some cases, the metadata of an attack path 405 may include an impact indication of the attack path 405. Moreover, the computing service may store the impact indication with the operationally independent attack signature 415 and the operationally independent attack variant signature of a respective attack path. As used herein, “impact” may be referred to as an outcome an attacker may achieve by exploiting a set of weaknesses or misconfigurations. As an example, a vulnerability on a network asset (e.g., a domain controller) may be exploited by an attacker to compromise the network 110 (e.g., obtain full domain compromise). In such an example, the compromise may be the impact of the vulnerability on the network asset. Impact may be used to translate a technical issue or vulnerability to a potential business impact. The impact may be relevant to scoring or ranking various vulnerabilities, misconfigurations, and other deficiencies that led to the impact. In some examples, “impact” may be simply accessing the network assets or, in some other examples, “impact” may refer to a compromise event that occurs based on gaining access. Further, an impact of a respective attack path 405 may include an indication of a final node 410 in the sorted list of node 410 adjacency information. Additionally, or alternatively, the final node 410 may represent the overall compromise of an attack path 405 associated with a pentesting operation.

In some cases, the “impact” may be an overlay of what is in the pentesting environment with real-world attack paths 405 using respective operationally independent attack signatures 415 and operationally independent attack variant signatures. In some examples, to enable the computing service to output such information, users or the one or more devices associated with an autonomous pentesting operation may provide the computing service with additional metadata. In some cases, the additional metadata may include indications of whether a structure associated with a respective operationally independent attack signature 415 has been seen in a real attack path 405 (e.g., in response to an attacker or fraudulent user performing an attack on a network 110). Further, as the information may be anonymous, the computing service may be capable of receiving information from multiple different sources (e.g., different tenants, organizations, users, among others). Moreover, utilizing such information, the computing service may be capable of computing the quantity indication 435 for a respective attack path 405 to indicate whether the respective attack path 405 associated with a respective operationally independent attack signature 415 is relatively common or uncommon. For example, the computing service may indicate, via a respective quantity indication 435, within the information associated with the one or more previous autonomous pentesting operations associated with the operationally independent attack signature 415 an indication of a quantity of occurrences of a respective attack path 405 within the one or more previous autonomous pentesting operations.

In some examples, the computing service may also output, via the information associated with the one or more previous autonomous pentesting operations associated with a respective operationally independent attack signature 415, an indication of one or mitigation techniques for a respective attack path 405 that is associated with the respective operationally independent attack signature 415. For example, the computing service may determine that similar attack paths 405 for other tenants or companies have been identified and such tenants or companies have mitigated one or more security risks associated with a respective attack path 405. Thus, to aid tenants or companies, the computing service may indicate one or more mitigation techniques that other tenants or companies have implemented in response to identifying a similar attack path 405.

Therefore, using the techniques of the present disclosure, the computing service may provide lookup functionalities to users of an autonomous pentesting service or to the one or more devices associated with an autonomous pentesting operation. Using the lookup functionalities, the computing service may allow users or devices the capability to look up attack paths 405 that are interesting or worth investing further and the capability to identify pentesting operations that include similar attack path 405 structures. Further, if there are patterns that the autonomous pentesting service should avoid or utilize, the computing service can detect patterns in configurations of similar pentesting operations and provide such feedback to admins setting up pentesting operations within the autonomous pentesting service or to other users or customers. For example, the computing service may indicate that all customers who performed a pentesting operation that successfully resulted in a respective compromise event configured the pentesting operations in accordance with a first configuration. Using such patterns, the autonomous pentesting service, the computing service, or both, may generate and display analytics to view global trends across pentesting operations. For example, the display may indicate that certain operationally independent attack signatures 415 are becoming more common in attacks. Further, the display may include a view illustrating a quantity of occurrences of operationally independent attack signatures 415 from a time series perspective (e.g., certain operationally independent attack signatures 415 being identified at a relatively higher frequency). Additionally, or alternatively, the display may indicate operationally independent attack signatures 415 that deviate from based operationally independent attack signatures 415 and to display additional uncommon attack trends being identified.

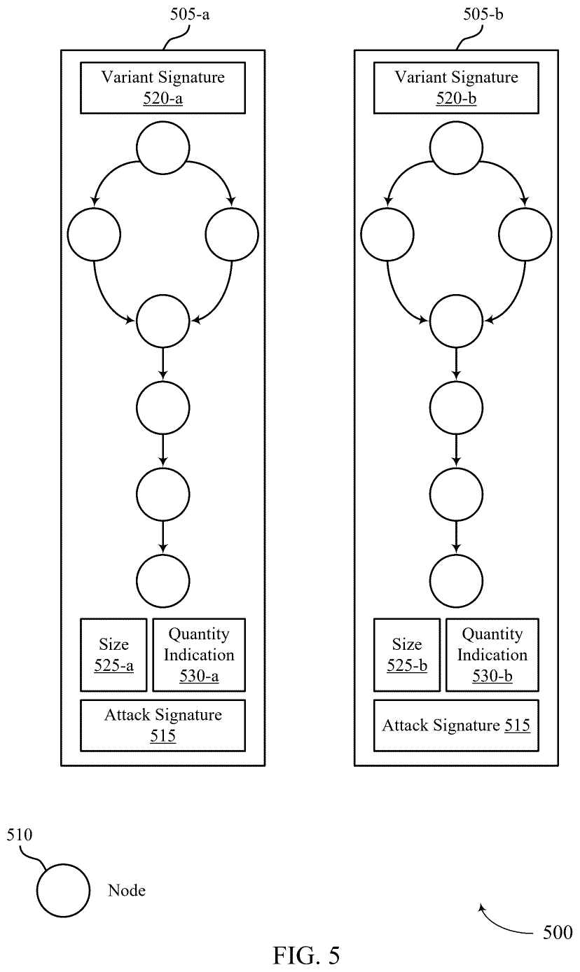

Thus, the techniques of the present disclosure may enable users of an autonomous pentesting to obtain interesting and helpful information, trends, analytics, recommendations to use to enhance the security of a network 110 and to perform subsequent pentesting operations. Moreover, the techniques of the present disclosure may enable users to view what attack paths 405 and operationally independent attack signatures 415 are common across an industry to ensure that the user is more knowledgeable and informed when implementing security procedures. Further descriptions of the techniques of the present disclosure may be described elsewhere herein, such as with reference to FIG. 5. For example, FIG. 5 may illustrate and describe variants 420 of a respective attack path 405 that have the same operationally independent attack signature 415.

FIG. 5 shows an example of attack path diagrams 500 that supports operationally independent attack signatures in autonomous pentesting in accordance with aspects of the present disclosure. The attack path diagrams 500 may implement or be implemented by the computing environment 100, the autonomous pentest map 200, the computing environment 300, the attack path diagrams 400, or any combination thereof. For example, the attack path diagrams 500 may illustrate an attack path 505-a that includes one or more nodes 510 and an attack path 505-b that includes one or more nodes 510. In some cases, the attack path 505-a and the attack path 505-b may both be associated with an operationally independent attack signature 515 that is the same for the attack path 505-a and the attack path 505-b. Moreover, the attack path 505-a and the attack path 505-b may each be associated with an operationally independent attack variant signature 520 (e.g., an operationally independent attack variant signature 520-a for the attack path 505-a and an operationally independent attack variant signature 520-b for the attack path 505-b).

In some examples, the attack path 505-a and the attack path 505-b may both be associated with the same operationally independent attack signature 515. Thus, the attack path 505-a and the attack path 505-b may be variant attack paths that have the same attack graph shape or structure. Further, each attack path 505 may be associated with a size indicator 525 (e.g., a size indicator 525-a for the attack path 505-a and a size indicator 525-b for the attack path 505-b) and a quantity indication 530 (e.g., a quantity indication 530-a for the attack path 505-a and a quantity indication 530-b for the attack path 505-b). In some cases, since the attack path 505-a and the attack path 505-b have the same node 510 structure, both attack paths may have the same size indicator 525 (e.g., both attack paths 505 may have the same quantity of nodes 510 and the same node 510 length). Further, since the attack path 505-a and the attack path 505-b are associated with different metadata, the quantity indication 530 for each respective attack path 505 may be different. For example, the set of actions and the impact of the attack path 505-a and the attack path 505-b may be different, the quantity indication 530 for the attack path 505-a and the attack path 505-b may be different.

In some cases, to obtain information associated with different variant attack paths of an operationally independent attack signature 515, a user may search for a list of attack paths 505 that have the same operationally independent attack signature 515. In such searching, to prevent exposing tenant-specific data, a computing service that manages the operationally independent attack signatures 515 and the operationally independent attack variant signatures 520 may limit the return result to attack paths 505 from pentesting operations performed by the tenant that requested the information via the search. For example, a tenant may perform a set of pentesting operations that may result in multiple different attack paths. After execution of the pentesting operations, to perform analysis, the user may request for information associated with the pentesting operations. In some cases, as described elsewhere herein, the computing service may obtain a request for information via a search query. In some examples, the computing service may limit responses to operationally independent attack signatures 515 to limit data exposure. In some other examples, the computing service may output (e.g., return) a response that includes one or more operationally independent attack variant signatures 520 based on an identification that each respective operationally independent attack variant signature 520 is associated with the same tenant or user the output the search query.

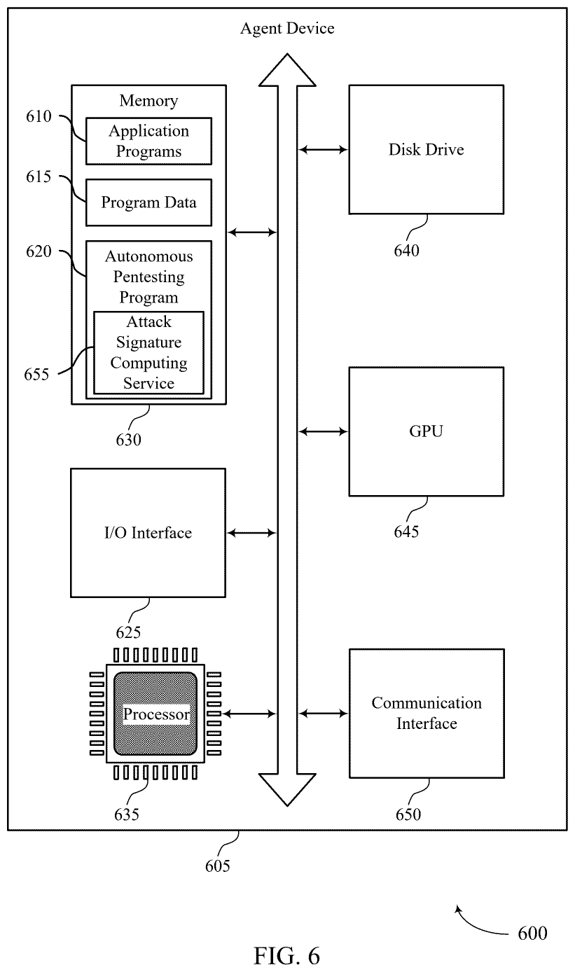

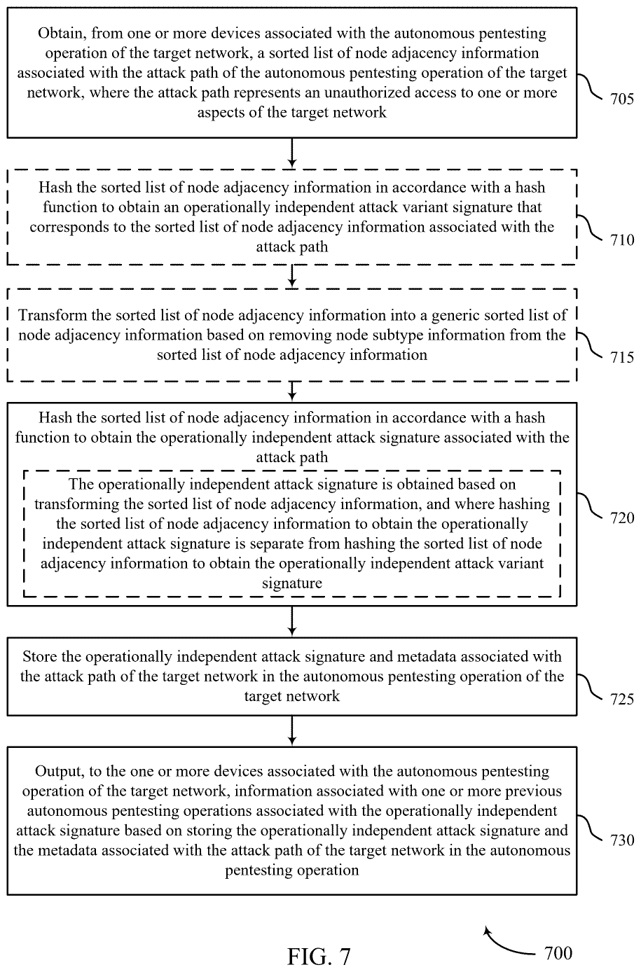

Thus, the techniques of the present disclosure may enable the computing service to generate operationally independent attack signatures 515 and operationally independent attack variant signatures 520 for respective attack paths 505. Utilizing the operationally independent attack signatures 515 and the operationally independent attack variant signatures 520, users may be capable of requesting for information about previous pentesting operations to further enhance the security of a network 110. Further description of the techniques of the present disclosure may be described elsewhere herein, such as with reference to FIGS. 6 and 7.

FIG. 6 shows a diagram of a system 600 including an agent device 605 that supports operationally independent attack signatures in autonomous pentesting in accordance with aspects of the present disclosure. The agent device 605 may be an example of a device or server on which an autonomous pentesting agent 105 is deployed as described herein. The agent device 605 may include components for operationally independent attack signatures in autonomous pentesting, such as a memory 630 including application programs 610, program data 615, an autonomous pentesting program 620, and an attack signature manager 655; an input/output (I/O) interface 625; a processor 635; a disk drive 640; a graphics processing unit (GPU) 645; and a communication interface 650. Each of these components may communicate, directly or indirectly, with one another (e.g., via one or more buses, communications links, communications interfaces, or any combination thereof).

The I/O interface 625 may support connection of the agent device 605 with one or more other devices. For example, the agent device 605 may connect to keyboards, mice, printers, hard disks, or the like via the I/O interface 625. The I/O interface 625 may communicate with the processor 635. That is, the processor 635 may process signals from devices connected to the agent device 605 via the I/O interface 625.

Memory 630 may include RAM, ROM, or both. The memory 630 may store computer-readable, computer-executable software including instructions that, when executed, cause at least one processor 635 to perform various functions described herein, such as functions supporting operationally independent attack signatures in autonomous pentesting. In some cases, the memory 630 may contain, among other things, a basic input/output system (BIOS), which may control basic hardware or software operation such as the interaction with peripheral components or devices. The memory 630 may be an example of a single memory or multiple memories. For example, the agent device 605 may include one or more memories 630.

The application programs 610 in the memory 630 may be examples of app(s) 140 as described with reference to FIG. 1. For example, the application programs 610 may be installed on the memory 630 of the agent device 605, among other devices in a network. The application programs 610 may be examples of software applications or computer programs that are implemented to carry out one or more functions or tasks.

The program data 615 may be data related to the application programs 610. Program data 615 may be an example of or refer to running data of programs and applications installed on the memory 630 of the agent device 605. In some examples, the program data 615 may include various data, including code that allows the application programs 610 to perform the one or more functions or tasks.

The processor 635 may include an intelligent hardware device, (e.g., a general-purpose processor, a digital signal processor (DSP), a CPU, a microcontroller, an application-specific integrated circuit (ASIC), a field programmable gate array (FPGA), a programmable logic device, a discrete gate or transistor logic component, a discrete hardware component, or any combination thereof). The processor 635 may be configured to execute computer-readable instructions stored in at least one memory 630 to perform various functions (e.g., functions or tasks supporting operationally independent attack signatures in autonomous pentesting). Though a single processor 635 is depicted in the example of FIG. 6, it is to be understood that the system 600 may include any quantity of one or more of processors 635 and that a group of processors 635 may collectively perform one or more functions ascribed herein to a processor, such as the processor 635. The processor 635 may be an example of a single processor or multiple processors. For example, the agent device 605 may include one or more processors 635.

The disk drive 640 may be configured to store data that is generated, processed, stored, or otherwise used by the system 600. In some cases, the disk drive 640 may include one or more hard disk drives (HDDs), one or more solid-state drives (SSDs), or both. In some examples, the disk drive 640 may be an example of a single database, a distributed database, multiple distributed databases, a data store, a data lake, or an emergency backup database. In some examples, the disk drive 640 may be an example of one or more components described with reference to FIG. 1.

GPU 645 may be configured to store graphics-related data. The GPU 645 may store and manage data related to graphics and video processing. In some examples, the GPU 645 may be an example of or a component of a graphics card. The GPU 645 may use components of the memory 630, including the RAM, for temporary storage. For example, the GPU 645 may move data from the RAM of the memory 630 to the GPU 645 for graphics and video processing.

The communication interface 650 may enable the agent device 605 to exchange information (e.g., input information, output information, or both) with other systems or devices (not shown). For example, the communication interface 650 may enable the agent device 605 to connect to a network (e.g., a network 110 as described herein). The communication interface 650 may include one or more wireless network interfaces, one or more wired network interfaces, or any combination thereof.

The autonomous pentesting program 620 may be an example of a program of an autonomous pentesting service that is installed on the memory 630 of the agent device 605. The autonomous pentesting program 620 may execute an autonomous pentest of a network accessed by the agent device 605, such as accessed via the communication interface 650. That is, the autonomous pentesting program 620 may be configured to perform an autonomous pentest as described herein, including an autonomous pentest obtaining an operationally independent attack signature associated with an attack path of an autonomous pentesting operation of a target network.

The attack signature computing service 655 may support obtaining an operationally independent attack signature associated with an attack path of an autonomous pentesting operation of a target network in accordance with examples as disclosed herein. For example, the attack signature computing service 655 may be configured as or otherwise support a means for obtaining, from one or more devices associated with the autonomous pentesting operation of the target network, a sorted list of node adjacency information associated with the attack path of the autonomous pentesting operation of the target network, where the attack path represents an unauthorized access to one or more aspects of the target network. The attack signature computing service 655 may be configured as or otherwise support a means for hashing the sorted list of node adjacency information in accordance with a hash function to obtain the operationally independent attack signature associated with the attack path. The attack signature computing service 655 may be configured as or otherwise support a means for storing the operationally independent attack signature and metadata associated with the attack path of the target network in the autonomous pentesting operation of the target network. The attack signature computing service 655 may be configured as or otherwise support a means for outputting, to the one or more devices associated with the autonomous pentesting operation of the target network, information associated with one or more previous autonomous pentesting operations associated with the operationally independent attack signature based on storing the operationally independent attack signature and the metadata associated with the attack path of the target network in the autonomous pentesting operation.

By including or configuring the attack signature computing service 655 in accordance with examples as described herein, the agent device 605 may support techniques for improved network security.

FIG. 7 shows a flowchart illustrating a method 700 that supports operationally independent attack signatures in autonomous pentesting in accordance with aspects of the present disclosure. The operations of the method 700 may be implemented by an agent device 705 or its components as described herein. In some examples, an agent device may execute a set of instructions to control the functional elements of the agent device to perform the described functions. Additionally, or alternatively, the agent device may perform aspects of the described functions using special-purpose hardware.

At 705, the method may include obtaining, from one or more devices associated with the autonomous pentesting operation of the target network, a sorted list of node adjacency information associated with the attack path of the autonomous pentesting operation of the target network, where the attack path represents an unauthorized access to one or more aspects of the target network. The operations of 705 may be performed in accordance with examples as disclosed herein.

At 710, the method may include hashing the sorted list of node adjacency information in accordance with the hash function to obtain an operationally independent attack variant signature that corresponds to the sorted list of node adjacency information associated with the attack path. The operations of 710 may be performed in accordance with examples as disclosed herein.

At 715, the method may include transforming the sorted list of node adjacency information into a generic sorted list of node adjacency information based on removing node subtype information from the sorted list of node adjacency information. The operations of 715 may be performed in accordance with examples as disclosed herein.

At 720, the method may include hashing the sorted list of node adjacency information in accordance with a hash function to obtain the operationally independent attack signature associated with the attack path, where the operationally independent attack signature is obtained based on transforming the sorted list of node adjacency information, and where hashing the sorted list of node adjacency information to obtain the operationally independent attack signature is separate from hashing the sorted list of node adjacency information to obtain the operationally independent attack variant signature. The operations of 720 may be performed in accordance with examples as disclosed herein.

At 725, the method may include storing the operationally independent attack signature and metadata associated with the attack path of the target network in the autonomous pentesting operation of the target network. The operations of 725 may be performed in accordance with examples as disclosed herein.

At 730, the method may include outputting, to the one or more devices associated with the autonomous pentesting operation of the target network, information associated with one or more previous autonomous pentesting operations associated with the operationally independent attack signature based on storing the operationally independent attack signature and the metadata associated with the attack path of the target network in the autonomous pentesting operation. The operations of 730 may be performed in accordance with examples as disclosed herein.

The following provides an overview of aspects of the present disclosure:

Aspect 1: A method for of obtaining an operationally independent attack signature associated with an attack path of an autonomous pentesting operation of a target network, comprising: obtaining, from one or more devices associated with the autonomous pentesting operation of the target network, a sorted list of node adjacency information associated with the attack path of the autonomous pentesting operation of the target network, wherein the attack path represents an unauthorized access to one or more aspects of the target network; hashing the sorted list of node adjacency information in accordance with a hash function to obtain the operationally independent attack signature associated with the attack path; storing the operationally independent attack signature and metadata associated with the attack path of the target network in the autonomous pentesting operation of the target network; and outputting, to the one or more devices associated with the autonomous pentesting operation of the target network, information associated with one or more previous autonomous pentesting operations associated with the operationally independent attack signature based at least in part on storing the operationally independent attack signature and the metadata associated with the attack path of the target network in the autonomous pentesting operation.

Aspect 2: The method of aspect 1, wherein hashing the sorted list of node adjacency information comprises: hashing the sorted list of node adjacency information in accordance with the hash function to obtain an operationally independent attack variant signature that corresponds to the sorted list of node adjacency information associated with the attack path; and transforming the sorted list of node adjacency information into a generic sorted list of node adjacency information based at least in part on removing node subtype information from the sorted list of node adjacency information, wherein the operationally independent attack signature is obtained based at least in part on transforming the sorted list of node adjacency information, and wherein hashing the sorted list of node adjacency information to obtain the operationally independent attack signature is separate from hashing the sorted list of node adjacency information to obtain the operationally independent attack variant signature.

Aspect 3: The method of aspect 2, wherein storing the operationally independent attack signature and the metadata comprises: storing both the operationally independent attack signature and the operationally independent attack variant signature with the metadata associated with the attack path.

Aspect 4: The method of any of aspects 2 through 3, wherein the operationally independent attack signature is associated with a node structure of the attack path in the autonomous pentesting operation of the target network and a node type of the attack path and the operationally independent attack variant signature is associated with the node structure of the attack path, the node type of the attack path, and the node subtype information.

Aspect 5: The method of any of aspects 1 through 4, wherein the metadata associated with the attack path of the target network in the autonomous pentesting operation of the target network comprises an indication of a final node in the sorted list of node adjacency information.

Aspect 6: The method of any of aspects 1 through 5, wherein outputting the information associated with the one or more previous autonomous pentesting operations comprises: outputting, to the one or more devices associated with the autonomous pentesting operation of the target network, an indication of one or more tags associated with the one or more previous autonomous pentesting operations.

Aspect 7: The method of any of aspects 1 through 6, wherein obtaining the sorted list of node adjacency information comprises: obtaining, from the one or more devices associated with the autonomous pentesting operation of the target network, a request for the operationally independent attack signature associated with the sorted list of node adjacency information, the request comprising an indication of the sorted list of node adjacency information, wherein the sorted list of node adjacency information is obtained based at least in part on the request; and outputting, to the one or more devices associated with the autonomous pentesting operation of the target network, the operationally independent attack signature associated with the sorted list of node adjacency information in response to the request, wherein hashing the sorted list of node adjacency information and storing the operationally independent attack signature in response to obtaining the sorted list of node adjacency information is based at least in part on an existence of the operationally independent attack signature.

Aspect 8: The method of any of aspects 1 through 7, further comprising: obtaining, from the one or more devices associated with the autonomous pentesting operation of the target network, a request for a respective sorted list of node adjacency information that is associated with a respective operationally independent attack signature, the request comprising an indication of the respective operationally independent attack signature; and outputting, to the one or more devices associated with the autonomous pentesting operation of the target network, the respective sorted list of node adjacency information that is associated with the respective operationally independent attack signature in response to the request.

Aspect 9: The method of any of aspects 1 through 8, further comprising: obtaining, from the one or more devices associated with the autonomous pentesting operation of the target network, a request for one or more operationally independent attack signatures associated with the one or more previous autonomous pentesting operations that satisfy a similarity threshold with the operationally independent attack signature associated with the attack path, the request comprising an indication of the operationally independent attack signature and the similarity threshold; and outputting, to the one or more devices associated with the autonomous pentesting operation of the target network via the information associated with the one or more previous autonomous pentesting operations, an indication of the one or more operationally independent attack signatures associated with the one or more previous autonomous pentesting operations that satisfy the similarity threshold, wherein the indication is output via the information based at least in part on obtaining the request.

Aspect 10: The method of any of aspects 1 through 9, further comprising: obtaining, from the one or more devices associated with the autonomous pentesting operation of the target network, a request for one or more operationally independent attack signatures associated with the one or more previous autonomous pentesting operations that satisfy a similarity threshold with the sorted list of node adjacency information associated with the attack path, the request comprising an indication of the sorted list of node adjacency information and the similarity threshold; and outputting, to the one or more devices associated with the autonomous pentesting operation of the target network via the information associated with the one or more previous autonomous pentesting operations, an indication of the one or more operationally independent attack signatures associated with the one or more previous autonomous pentesting operations that satisfy the similarity threshold, wherein the indication is output via the information based at least in part on obtaining the request.

Aspect 11: The method of any of aspects 1 through 10, wherein the information associated with the one or more previous autonomous pentesting operations associated with the operationally independent attack signature comprises an indication of a quantity of occurrences of the attack path within the one or more previous autonomous pentesting operations.

Aspect 12: The method of any of aspects 1 through 11, wherein the information associated with the one or more previous autonomous pentesting operations associated with the operationally independent attack signature comprises an indication of one or mitigation techniques for a respective attack path that is associated with the operationally independent attack signature.

Aspect 13: The method of any of aspects 1 through 12, further comprising: obtaining, from the one or more devices associated with the autonomous pentesting operation of the target network via a user interface, a request for the information associated with the one or more previous autonomous pentesting operations, the request comprising a search query for the information, wherein the information is obtained based at least in part on the request.

Aspect 14: The method of aspect 13, wherein the search query is a Java script notation (JSON)-based search, a structural-based search, a graphical-based search, or any combination thereof.

Aspect 15: An apparatus for of obtaining an operationally independent attack signature associated with an attack path of an autonomous pentesting operation of a target network, comprising one or more memories storing processor-executable code, and one or more processors coupled with the one or more memories and individually or collectively operable to execute the code to cause the apparatus to perform a method of any of aspects 1 through 14.

Aspect 16: An apparatus for of obtaining an operationally independent attack signature associated with an attack path of an autonomous pentesting operation of a target network, comprising at least one means for performing a method of any of aspects 1 through 14.

Aspect 17: A non-transitory computer-readable medium storing code for of obtaining an operationally independent attack signature associated with an attack path of an autonomous pentesting operation of a target network, the code comprising instructions executable by one or more processors to perform a method of any of aspects 1 through 14.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for of obtaining an operationally independent attack signature associated with an attack path of an autonomous pentesting operation of a target network, comprising:
obtaining, from one or more devices associated with the autonomous pentesting operation of the target network, a sorted list of node adjacency information associated with the attack path of the autonomous pentesting operation of the target network, wherein the attack path represents an unauthorized access to one or more aspects of the target network;
hashing the sorted list of node adjacency information in accordance with a hash function to obtain the operationally independent attack signature associated with the attack path;
storing the operationally independent attack signature and metadata associated with the attack path of the target network in the autonomous pentesting operation of the target network; and
outputting, to the one or more devices associated with the autonomous pentesting operation of the target network, information associated with one or more previous autonomous pentesting operations associated with the operationally independent attack signature based at least in part on storing the operationally independent attack signature and the metadata associated with the attack path of the target network in the autonomous pentesting operation.

2. The method of claim 1, wherein hashing the sorted list of node adjacency information comprises:
hashing the sorted list of node adjacency information in accordance with the hash function to obtain an operationally independent attack variant signature that corresponds to the sorted list of node adjacency information associated with the attack path; and
transforming the sorted list of node adjacency information into a generic sorted list of node adjacency information based at least in part on removing node subtype information from the sorted list of node adjacency information, wherein the operationally independent attack signature is obtained based at least in part on transforming the sorted list of node adjacency information, and wherein hashing the sorted list of node adjacency information to obtain the operationally independent attack signature is separate from hashing the sorted list of node adjacency information to obtain the operationally independent attack variant signature.

3. The method of claim 2, wherein storing the operationally independent attack signature and the metadata comprises:
storing both the operationally independent attack signature and the operationally independent attack variant signature with the metadata associated with the attack path.

4. The method of claim 2, wherein the operationally independent attack signature is associated with a node structure of the attack path in the autonomous pentesting operation of the target network and a node type of the attack path and the operationally independent attack variant signature is associated with the node structure of the attack path, the node type of the attack path, and the node subtype information.

5. The method of claim 1, wherein the metadata associated with the attack path of the target network in the autonomous pentesting operation of the target network comprises an indication of a final node in the sorted list of node adjacency information.

6. The method of claim 1, wherein outputting the information associated with the one or more previous autonomous pentesting operations comprises:
outputting, to the one or more devices associated with the autonomous pentesting operation of the target network, an indication of one or more tags associated with the one or more previous autonomous pentesting operations.

7. The method of claim 1, wherein obtaining the sorted list of node adjacency information comprises:
obtaining, from the one or more devices associated with the autonomous pentesting operation of the target network, a request for the operationally independent attack signature associated with the sorted list of node adjacency information, the request comprising an indication of the sorted list of node adjacency information, wherein the sorted list of node adjacency information is obtained based at least in part on the request; and
outputting, to the one or more devices associated with the autonomous pentesting operation of the target network, the operationally independent attack signature associated with the sorted list of node adjacency information in response to the request, wherein hashing the sorted list of node adjacency information and storing the operationally independent attack signature in response to obtaining the sorted list of node adjacency information is based at least in part on an existence of the operationally independent attack signature.

8. The method of claim 1, further comprising:
obtaining, from the one or more devices associated with the autonomous pentesting operation of the target network, a request for a respective sorted list of node adjacency information that is associated with a respective operationally independent attack signature, the request comprising an indication of the respective operationally independent attack signature; and
outputting, to the one or more devices associated with the autonomous pentesting operation of the target network, the respective sorted list of node adjacency information that is associated with the respective operationally independent attack signature in response to the request.

9. The method of claim 1, further comprising:
obtaining, from the one or more devices associated with the autonomous pentesting operation of the target network, a request for one or more operationally independent attack signatures associated with the one or more previous autonomous pentesting operations that satisfy a similarity threshold with the operationally independent attack signature associated with the attack path, the request comprising an indication of the operationally independent attack signature and the similarity threshold; and
outputting, to the one or more devices associated with the autonomous pentesting operation of the target network via the information associated with the one or more previous autonomous pentesting operations, an indication of the one or more operationally independent attack signatures associated with the one or more previous autonomous pentesting operations that satisfy the similarity threshold, wherein the indication is output via the information based at least in part on obtaining the request.

10. The method of claim 1, further comprising:
obtaining, from the one or more devices associated with the autonomous pentesting operation of the target network, a request for one or more operationally independent attack signatures associated with the one or more previous autonomous pentesting operations that satisfy a similarity threshold with the sorted list of node adjacency information associated with the attack path, the request comprising an indication of the sorted list of node adjacency information and the similarity threshold; and
outputting, to the one or more devices associated with the autonomous pentesting operation of the target network via the information associated with the one or more previous autonomous pentesting operations, an indication of the one or more operationally independent attack signatures associated with the one or more previous autonomous pentesting operations that satisfy the similarity threshold, wherein the indication is output via the information based at least in part on obtaining the request.

11. The method of claim 1, wherein the information associated with the one or more previous autonomous pentesting operations associated with the operationally independent attack signature comprises an indication of a quantity of occurrences of the attack path within the one or more previous autonomous pentesting operations.

12. The method of claim 1, wherein the information associated with the one or more previous autonomous pentesting operations associated with the operationally independent attack signature comprises an indication of one or mitigation techniques for a respective attack path that is associated with the operationally independent attack signature.

13. The method of claim 1, further comprising:
obtaining, from the one or more devices associated with the autonomous pentesting operation of the target network via a user interface, a request for the information associated with the one or more previous autonomous pentesting operations, the request comprising a search query for the information, wherein the information is obtained based at least in part on the request.

14. The method of claim 13, wherein the search query is a Java script notation (JSON)-based search, a structural-based search, a graphical-based search, or any combination thereof.

15. An apparatus, comprising:
one or more memories storing processor-executable code; and
one or more processors coupled with the one or more memories and individually or collectively operable to execute the code to cause the apparatus to:
obtain, from one or more devices associated with an autonomous pentesting operation of a target network, a sorted list of node adjacency information associated with an attack path of the autonomous pentesting operation of the target network, wherein the attack path represents an unauthorized access to one or more aspects of the target network;
hash the sorted list of node adjacency information in accordance with a hash function to obtain an operationally independent attack signature associated with the attack path;
store the operationally independent attack signature and metadata associated with the attack path of the target network in the autonomous pentesting operation of the target network; and
output, to the one or more devices associated with the autonomous pentesting operation of the target network, information associated with one or more previous autonomous pentesting operations associated with the operationally independent attack signature based at least in part on storing the operationally independent attack signature and the metadata associated with the attack path of the target network in the autonomous pentesting operation.

16. The apparatus of claim 15, wherein, to hash the sorted list of node adjacency information, the one or more processors are individually or collectively operable to execute the code to cause the apparatus to:
hash the sorted list of node adjacency information in accordance with the hash function to obtain an operationally independent attack variant signature that corresponds to the sorted list of node adjacency information associated with the attack path; and
transform the sorted list of node adjacency information into a generic sorted list of node adjacency information based at least in part on removing node subtype information from the sorted list of node adjacency information, wherein the operationally independent attack signature is obtained based at least in part on transforming the sorted list of node adjacency information, and wherein hashing the sorted list of node adjacency information to obtain the operationally independent attack signature is separate from hashing the sorted list of node adjacency information to obtain the operationally independent attack variant signature.

17. The apparatus of claim 15, wherein the one or more processors are individually or collectively further operable to execute the code to cause the apparatus to:
obtain, from the one or more devices associated with the autonomous pentesting operation of the target network, a request for one or more operationally independent attack signatures associated with the one or more previous autonomous pentesting operations that satisfy a similarity threshold with the operationally independent attack signature associated with the attack path, the request comprising an indication of the operationally independent attack signature and the similarity threshold; and
output, to the one or more devices associated with the autonomous pentesting operation of the target network via the information associated with the one or more previous autonomous pentesting operations, an indication of the one or more operationally independent attack signatures associated with the one or more previous autonomous pentesting operations that satisfy the similarity threshold, wherein the indication is output via the information based at least in part on obtaining the request.

18. The apparatus of claim 15, wherein the information associated with the one or more previous autonomous pentesting operations associated with the operationally independent attack signature comprises an indication of a quantity of occurrences of the attack path within the one or more previous autonomous pentesting operations.

19. A non-transitory computer-readable medium storing code for of obtaining an operationally independent attack signature associated with an attack path of an autonomous pentesting operation of a target network, the code comprising instructions executable by one or more processors to:
obtain, from one or more devices associated with the autonomous pentesting operation of the target network, a sorted list of node adjacency information associated with the attack path of the autonomous pentesting operation of the target network, wherein the attack path represents an unauthorized access to one or more aspects of the target network;
hash the sorted list of node adjacency information in accordance with a hash function to obtain the operationally independent attack signature associated with the attack path;
store the operationally independent attack signature and metadata associated with the attack path of the target network in the autonomous pentesting operation of the target network; and
output, to the one or more devices associated with the autonomous pentesting operation of the target network, information associated with one or more previous autonomous pentesting operations associated with the operationally independent attack signature based at least in part on storing the operationally independent attack signature and the metadata associated with the attack path of the target network in the autonomous pentesting operation.

20. The non-transitory computer-readable medium of claim 19, wherein the instructions to hash the sorted list of node adjacency information are executable by the one or more processors to:
hash the sorted list of node adjacency information in accordance with the hash function to obtain an operationally independent attack variant signature that corresponds to the sorted list of node adjacency information associated with the attack path; and
transform the sorted list of node adjacency information into a generic sorted list of node adjacency information based at least in part on removing node subtype information from the sorted list of node adjacency information, wherein the operationally independent attack signature is obtained based at least in part on transforming the sorted list of node adjacency information, and wherein hashing the sorted list of node adjacency information to obtain the operationally independent attack signature is separate from hashing the sorted list of node adjacency information to obtain the operationally independent attack variant signature.
